(19) United States
(12) Patent Application Publication
(10) Pub. No.: US 2014/0209420 A1
(43) Pub. Date: Jul. 31, 2014

(54) DISC BRAKE, IN PARTICULAR FOR UTILITY VEHICLES, AND RETAINER SPRING IN SUCH A DISC BRAKE

(71) Applicant: WABCO Radbremsen GmbH, Mannheim (DE)

(72) Inventors: Hellmut Jaeger, Ludwigshafen (DE); Denny Moeller, Gossel (DE)

(21) Appl. No.: 14/233,369

(22) PCT Filed: Sep. 27, 2012
(86) PCT No.: PCT/EP2012/004066

§ 371 Date: Jan. 16, 2014

(30) Foreign Application Priority Data
Sep. 29, 2011 (DE) 10 2011 115 304.0

(51) Int. Cl. F16D 65/097; B60T 1/06

(52) U.S. Cl. CPC F16D 65/0971; B60T 1/065
USPC 188/72.1

(57) ABSTRACT

The invention relates to a disc brake, in particular for utility vehicles, comprising a brake lining that comprises a first protrusion located eccentrically in the thickness direction, a tensioning unit for pressing the brake lining against a brake disc, a pressure plate, via which the tensioning unit presses the brake lining against the brake disc when braking, and a first retainer spring for retaining the brake lining, which retainer spring comprises an opening for accommodating the first protrusion, wherein a projection on the retainer spring extends in the mounted state over the brake lining on one side in the axial direction of the brake disc.

### CROSS REFERENCE TO RELATED APPLICATION

The present application is a 35 U.S.C. 317 national phase entry application of, and claims priority to, International Patent Application No. PCT/EP2012/004066, filed Sep. 27, 2012, which claims priority to German Patent Application No. DE 102011115304.0, filed Sep. 29, 2011, the disclosures of which are hereby incorporated by reference in their entirety for all purposes.

### BACKGROUND

The invention relates to a disc brake, in particular for utility vehicles, with a brake lining that comprises a first protrusion located eccentrically in the thickness direction, a tensioning unit for pressing the brake lining against a brake disc, a pressure plate via which the tensioning unit presses the brake lining against the brake disc when braking, and a first retainer spring for retaining the brake lining, which retainer spring comprises an opening for receiving the first protrusion.

Disc brakes of the above-cited type are known, for example, from DE 10 2006 023 964 B3.

As a rule, a brake lining of a disc brake of the type under discussion here comprises a friction lining directed toward the brake disc, which lining is fastened on a brake lining carrier (back plate) that is metallic as a rule. Such brake linings are located on both sides of the brake disc. In particular in the case of utility vehicle disc brakes they are supported and guided in shaft guides of the brake caliper and/or of the brake carrier in the circumferential direction. As a rule, inner areas of the shaft guides serve as radial support, so that one can speak of an essentially U-shaped shaft.

Such brake linings are inserted into the shaft guides in caliper disc brakes via a radial caliper opening. In order to avoid flapping noises and as a security against a falling out of the brake, the brake linings are tensioned by retainer springs and a retainer (retainer bracket or retainer sheet) in the required position. On account of the weight and the size of utility vehicle brake linings, leaf springs with the necessary spring power are preferably used as retainer springs. These leaf springs extend along the upper area of the brake lining carrier. They are connected to the back plate so that they do not lose the contact.

The spring action, that is, the above-mentioned tensioning, does not occur until the until retainer, that runs transversely to the brake disc plane and is fastened above the retainer springs on the brake caliper—thus, bridging the radial opening, begins a function in that it presses the retainer spring(s) down.

A retainer spring constructed as an oblong leaf spring can be divided into at least three zones/action areas: the middle area, against which the retainer acts, and the lateral spring shanks running out on both sides of it which shanks correspond to corresponding contours of the lining carrier.

For many reasons, whether for a simplified mounting/dismounting, a rebound limitation of the lateral spring shanks during travel or the like, the retainer springs are connected in the prior art in such a manner to the brake lining carrier that they cannot be lost. For example, refer in this connection to EP 1 916 437 B1, DE 40 20 287 A1 and EP 0 694 702 A2, that show pertinent solutions in addition to the above already-mentioned DE 10 2006 023 964 B3.

By way of example, according to DE 10 2006 023 964 B3 the two brake linings and the pressure plate are provided with a retainer spring. If the brake linings provided with a retainer spring and the pressure also provided with a retainer spring are now inserted via the radial opening into the shaft guides, erroneous insertions frequently occur due to unprofessional lining association or due to a lack of assembly knowledge, which result only later in field use in erroneous functions and brake failures. For example, the tensioning-side brake lining can be inserted improperly rotated into the lining shaft, i.e., with the metallic back place facing the brake disc. It can also happen that the brake lining provided for the tensioning side is inserted with the retainer spring on the false brake disc side, that is, on the rim side, into the brake.

The pressure plate in a pertinent disc brake serves, among other things, to prevent an adjusting spindle provided in the disc brake from rotating about its axis. To this end the pressure plate comprises an opening that can be a passage opening into which an appropriate coupling member engages, as a result of which the adjusting spindle is prevented from the described rotation.

The invention has the basic problem of further developing the disc brake of the initially cited type in such a manner that the operating safety of the brake is increased and the assembly is simplified.

JP 20009058 102 A shows a disc brake without pressure plate and with a retainer spring that is not coupled in the axial direction to the retained brake lining.

### BRIEF DESCRIPTION OF THE DRAWINGS

FIG. 1 schematically shows a view of a disc brake in accordance with an exemplary embodiment of the invention,

FIG. 2 shows a perspective view of a brake lining with a retainer spring of the disc brake in accordance with FIG. 1,

FIG. 3 shows a view of the brake lining with the retainer spring according to FIG. 2,

FIG. 4 shows a top view onto the brake lining with the retainer spring according to FIG. 2,

FIG. 5 shows the same view as FIG. 2 but together with a pressure plate, and

FIG. 6 shows the same view as FIG. 2 but of another exemplary embodiment of the retainer spring.

### DETAILED DESCRIPTION

According to the invention the problem posed is solved with a disc brake according to claim 1.

If, for example, the tensioning-side brake lining is inserted with the retainer spring comprising the projection on the false brake disc side, that is, on the rim side into the brake, the projection is covered either with the caliper shank there or with the brake disc, as a result of which the erroneous insertion is immediately noticed. If the tensioning-side brake lining is inserted in an improperly rotated manner, that is, with the back plate facing the brake disc, the projection on the retainer spring is covered by the brake disc. Therefore, this erroneous insertion is also immediately noticed. The projection corresponds to the other structural components of the brake only in the proper insertion position in that it covers the pressure plate. Therefore, erroneous insertions are reliably avoided. The assembly is also simplified because erroneous insertions are “automatically” indicated.

According to the invention the projection is preferably constructed in one piece with the retainer spring. This keeps the number of parts low.

According to an especially preferred embodiment of the invention the projection can serve to retain the pressure plate. This reduces the number of parts even more because the pressure plate does not need its own retainer spring.

According to the invention the projection is preferably constructed as a second retainer spring. It therefore has the same functions as the first retainer spring and as a separate retainer spring provided in traditional disc brakes for the pressure plate.

According to an especially preferred embodiment of the invention the first and/or the second retainer spring(s) has/have lateral shanks and a middle area. This design is especially advantageous for the intended functions and actions of the retainer spring(s).

According to an especially preferred embodiment of the invention it is provided that a lateral shank of the first retainer spring is separated by a slot from the adjacent lateral shank of the second retainer spring. This construction allows the two adjacent, lateral shanks of the retainer springs to be pretensioned independently of one another and the required spring forces to be created in accordance with the slot length/s.

According to the invention the retainer springs can be constructed as desired. However, it is preferably provided that the first and/or the second retainer spring(s) is/are level or bent at least in sections or comprise(s) a radial projection facing inward or outward. Which construction is advantageous will be selected in accordance with the particular individual structural conditions.

According to the invention it is furthermore preferably provided that the projection has an opening for receiving a second protrusion formed on the pressure plate. As a result, the pressure plate is coupled to the projection.

Finally, it is provided in an especially preferred manner in accordance with the invention that the first opening is a passage opening and the first protrusion projects in the inserted state in the axial direction of the brake disc over a limitation of the first opening in order to form a rebound limitation for a lateral spring shank of the first retainer spring. This ensures that in the case of radial oscillations on poor road stretches the lateral spring shank can always be brought back into the initial position (rest position) because it is excluded that the coupling of the protrusion to the passage opening is lost.

In addition to the disc brake explained above in detail the invention also relates to a retainer spring of such a disc brake.

In the following the invention is explained in detail using preferred exemplary embodiments with reference made to the attached drawings with further details. In the drawings:

brake caliper 10 with an opening 12 belongs to the disc brake shown in the drawings. A rim-side brake lining 14, with a back plate 16 and a friction lining 18, and a tensioning-side brake lining 20 with a back plate 22 and a friction lining 24 are inserted into the brake via the opening 12. In order to retain the rim-side brake lining 14 a retention spring 26 is used. In order to retain the tensioning-side brake lining 20 a retainer spring 28 is used. The retainer springs 26 and 28 are pretensioned by a retainer bracket 30 that is stopped, for example, by a screw 32. Instead of the retainer bracket a retainer sheet or some other retainer device can be used. This also applies to the screws 30 serving for the fastening.

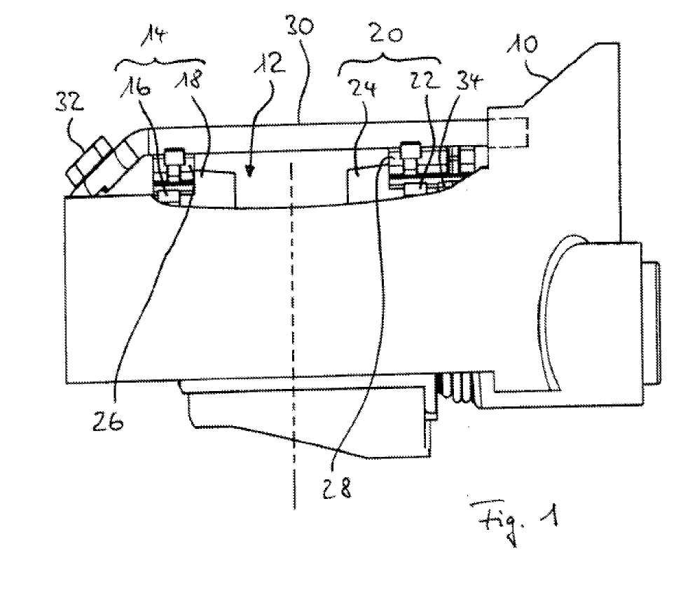

A tensioning unit that has a known construction and is therefore not shown in the drawings and is also not explained further is located inside the caliper 10 in FIG. 1 on the right side. The tensioning unit presses during braking against a pressure plate 34 that for its part presses the tensioning-side brake lining 20 in the direction of the brake disc, i.e., to the left in FIG. 1. The brake disc not shown in the drawings is located between the two brake linings 14 and 20.

The retainer spring 28 comprises a middle area 36 and two lateral spring shanks 38 and 40. The two spring shanks 38 and 40 have a passage opening 42 respectively 44 through which a protrusion 46 respectively 48 of the brake lining 20 extends. The two protrusions 46 and 48 have notches, of which one is designated by way of example by the reference numeral 50. It is attached in such a manner that a material overhang results by which the particular projection projects over a limitation of the associated passage opening in order form a rebound limitation for the particular lateral spring shank. The material overhang is not only limited to the notch(es) shown but rather the overhang can be formed and attached in many ways if this meets the function as a rebound limitation or prevention of loss.

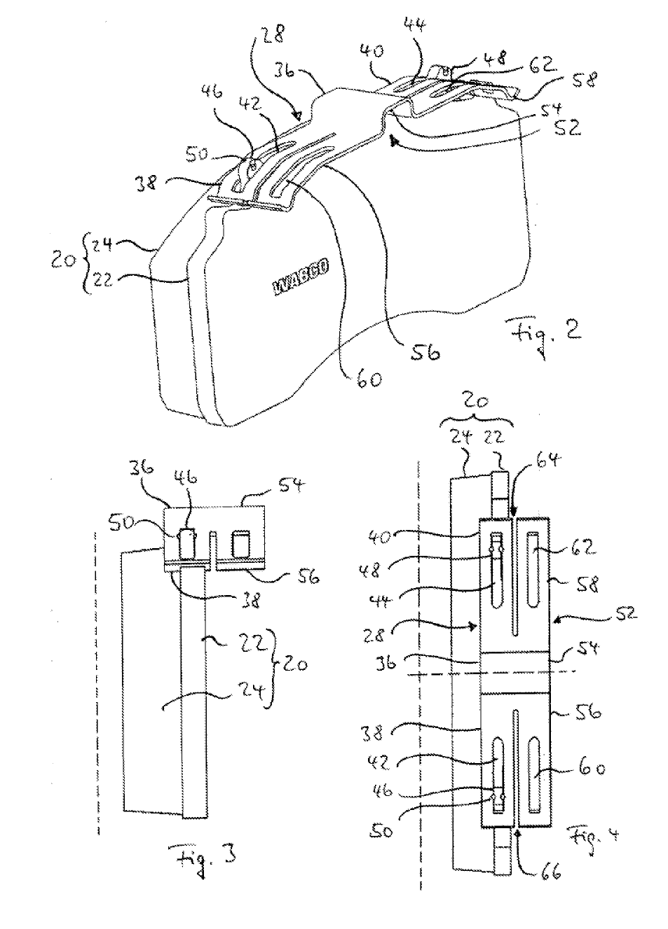

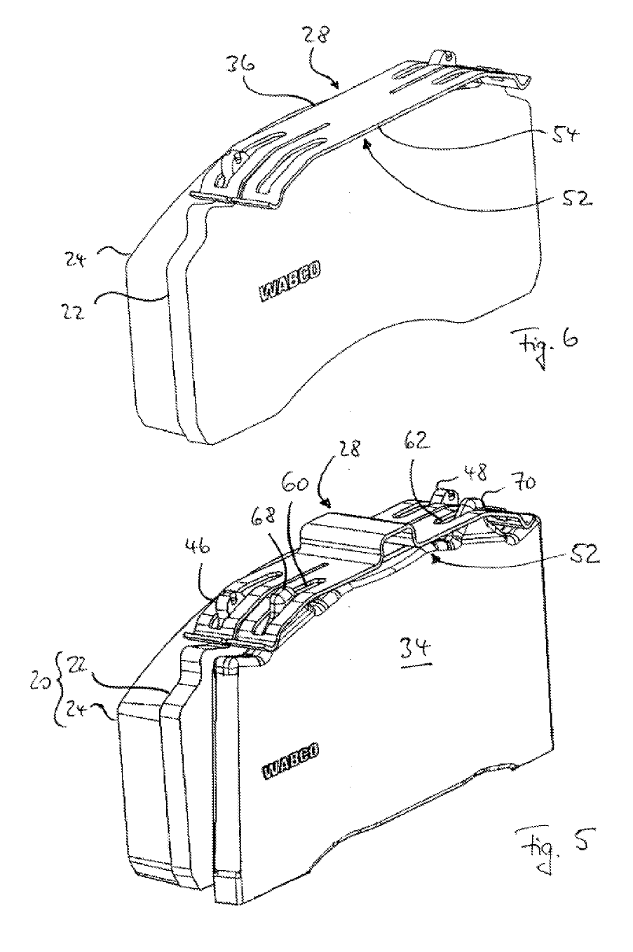

As can be gathered in particular from the FIGS. 2 to 4, the retainer spring 28 has a projection that projects in the assembled state over the back plate 22 of the brake lining 20. This projection is designated by the reference numeral 52. In the exemplary embodiment shown it is constructed in the shape of a retainer spring, for which reason the retainer spring 52 is also cited in the following.

The retainer spring 52 is shaped exactly like the retainer spring 28. They are constructed in one piece with one another. The retainer spring 52 has a middle area 54 and two lateral spring shanks 56, 58 with a passage opening 60 respectively 62. A slot 64 is located between the spring shanks 40 and 58. A slot 66 is located between the spring shanks 38 and 56. As a result, the spring shanks can swing out independently from one another. In contrast thereto, however, spring shanks adjacent to one another can also be constructed without a slot located between them.

In the assembled state projections 68, 70 of the pressure plate 34 extend through the openings 60 and 62 of the retainer spring 52 forming the projection in order to couple the pressure plate to the retainer spring in the direction of tensioning. Here no rebound limitation is provided in the exemplary embodiment shown.

In the exemplary embodiment according to FIG. 6 the middle area 36 and 54 of the retainer springs 28 and 52 are designed level, in contrast to which in the exemplary embodiment according to FIG. 2 it represents and forms a radial projection facing outwards. Which embodiment is used in practice is decided in accordance with the particular other structural conditions.

As a result of the fact that the two retainer springs 28 and 52 are constructed in one piece with one another the number of parts is reduced. Furthermore, an erroneous insertion is avoided because a falsely rotated placing of the retainer spring 28 or 52 on the brake lining 20 or a placing of the retainer spring(s) together with the brake lining on the rim side instead of on the tensioning side leads to incompatibilities. In a correct insertion the projection of the retainer spring 28, which projection is constructed in the form of the retainer spring 52, projects over the back plate 22 of the brake lining 20, where it is used to retain the pressure plate 34. In the case of the cited erroneous insertions it will not project (falsely rotated insertion), for example, over the back plate 22 but rather over the friction lining 24 or extend on the rim side into an area of the brake in which it strikes against other parts so that such an erroneous insertion is “automatically” pointed out. A service person who attempts such an erroneous insertion will therefore recognize the error in view of the cited incompatibilities and thereupon select the correct insertion position.

The features of the invention disclosed in the above specification, the claims and in the drawings can be essential for the realization of the invention in its various embodiments individually as well as in any combinations.

1. A disc brake, in particular for utility vehicles, with
a brake lining that comprises a first protrusion located eccentrically in a thickness direction,
a tensioning unit for pressing the brake lining against a brake disc,
a pressure plate via which the tensioning unit presses the brake lining against the brake disc when braking, and
a first retainer spring for retaining the brake lining, which first retainer spring comprises an opening for receiving the first protrusion, characterized by
a projection on the first retainer spring that projects on one side over the brake lining in an assembled state in an axial direction of the brake disc.

2. The disc brake according to claim 1, characterized in that the projection is constructed in one piece with the first retainer spring.

3. The disc brake according to claim 1, characterized in that the projection serves to retain the pressure plate.

4. The disc brake according to claim 1 characterized in that the projection is constructed as a second retainer spring.

5. The disc brake according to claim 4, characterized in that the first or the second retainer spring comprises two lateral shanks and one middle area.

6. The disc brake according to claim 5, characterized in that a lateral shank of the first retainer spring is separated by a slot from an adjacent lateral shank of the second retainer spring.

7. The disc brake according to claim 1, characterized in that the first or the second retainer spring is level or bent at least in sections or comprises an inwardly or outwardly facing radial projection.

8. The disc brake according to claim 1, characterized in that the projection has an opening for receiving a second protrusion formed on the pressure plate.

9. The disc brake according to claim 1, characterized in that
the opening is a passage opening and that
the first protrusion projects in an inserted state in the axial direction of the brake disc over a limitation of the opening in order to form a rebound limitation for a lateral spring shank of the first retainer spring.

10. A retainer spring of a disc brake, comprising an opening for receiving a first protrusion of a brake lining of the disc brake, and a projection that projects on one side over the brake lining in an assembled state in an axial direction of a brake disc of the disc brake,
wherein the disc brake includes a tensioning unit for pressing the brake lining against the brake disc and a pressure plate via which the tensioning unit presses the brake lining against the brake disc when braking.
